(19) United States
(12) Patent Application Publication
(10) Pub. No.: US 2019/0221849 A1
(43) Pub. Date: Jul. 18, 2019

(54) GRAPHENE STRUCTURE, METHOD OF PRODUCING GRAPHENE AND LITHIUM-ION BATTERY ELECTRODE INCLUDING GRAPHENE

(71) Applicant: Chung Yuan Christian University, Taoyuan City (TW)

(72) Inventors: Wei-Jen Liu, Taoyuan City (TW); Jhao-Yi Wu, New Taipei City (TW); Pin-Chun Lin, Taoyuan City (TW); Yen-Yu Yeh, Taoyuan City (TW); Cheng-Yi Lin, Taoyuan City (TW)

(73) Assignee: Chung Yuan Christian University, Taoyuan City (TW)

(21) Appl. No.: 16/166,178

(22) Filed: Oct. 22, 2018

(30) Foreign Application Priority Data
Jan. 17, 2018 (TW) 107101616

(51) Int. Cl. H01M 4/62; H01M 10/0525; C01B 32/182; C01B 32/19

(52) U.S. Cl. CPC H01M 4/625; H01M 10/0525; H01M 2004/028; C01B 32/19; C01B 32/182

(57) ABSTRACT

A method of producing graphene including the following steps is provided. A graphite material is dispersed in a solution to form a graphite suspension solution. A first crushing process and a second crushing process are performed on the graphite suspension solution sequentially to crush the graphite material, so as to form the graphene. The first crushing process includes applying a first pressure to the graphite suspension solution, and the second crushing process includes applying a second pressure to the graphite suspension solution. The second pressure is greater than the first pressure.

### CROSS-REFERENCE TO RELATED APPLICATION

This application claims the priority benefit of Taiwan application serial no. 107101616, filed on Jan. 17, 2018. The entirety of the above-mentioned patent application is hereby incorporated by reference herein and made a part of this specification.

### BACKGROUND OF THE INVENTION

### Field of the Invention

The present disclosure relates to a field of producing graphene. More particularly, the present disclosure relates to a graphene structure having low-defect density, a method of producing the graphene from a graphite material and a lithium-ion battery electrode including the graphene.

### Description of Related Art

In recent years, graphene has attracted the attention of the scientific community based on unique mechanical and electrical properties. The graphene is a material extracted from graphite, wherein 1 micron of graphite includes about 3 million layers of graphene. Structurally, the graphene is an allotrope of carbon and has a two dimensional, atomic grade and single atomic thickness honeycomb pattern structure.

The graphene has many unique properties, wherein the most practical property is high electrical conductivity and high thermal conductivity. Based on these uniqueness, the graphene has been widely used in various fields including fields of medicine (e.g., tissue engineering, biological imaging, polymerase chain reaction (PCR), detection and diagnostic instruments, drug delivery and bio-micromechanical systems), electronics (e.g., transistors, transparent conductive electrodes, frequency multipliers, optoelectronics, quantum dots, organic electronics and spintronics), light treatment (e.g., light modulators, infrared detection and light detectors), energy processing (e.g., energy generation and energy storage) and water treatment (e.g., removing contaminant substances and water filtration).

The related industries have developed several methods to produce the graphene recently. However, all these methods have disadvantages, such as low yield, low purity, high price, high-defect density and/or only small-scale production.

In addition, even the lithium-ion batteries mostly use the graphite as a negative electrode or use the graphite as a conductive additive of the electrode at present, battery capacitance, cyclic charge and discharge and rapid charge and discharge performance of the corresponding lithium-ion battery still need to be improved.

Therefore, an improved method is urgently needed in the related field to effectively produce the graphene having low-defect density and high electrical conductivity. In addition, it is necessary to propose an electrode material or a conductive additive of the electrode of the lithium-ion battery to improve the battery capacitance, cyclic charge and discharge and rapid charge and discharge performance of the lithium-ion battery.

### SUMMARY OF THE INVENTION

According to an embodiment of the invention, a graphene structure is provided. A material defect ratio (D/G ratio) of the graphene structure is less than 0.24, and the graphene structure is obtained by crushing a graphite material suspension solution.

According to an embodiment of the invention, the method of crushing the graphite material suspension solution includes the following steps. A first crushing process and a second crushing process are performed on the graphite suspension solution sequentially to crush a graphite material in the graphite suspension solution, so as to form graphene. The first crushing process includes applying a first pressure to the graphite suspension solution, and the second crushing process includes applying a second pressure to the graphite suspension solution. The second pressure is greater than the first pressure.

According to an embodiment of the invention, a method of producing graphene including the following steps is provided. A graphite material is dispersed in a solution to form a graphite suspension solution. A first crushing process and a second crushing process are performed on the graphite suspension solution sequentially to crush the graphite material, so as to form the graphene. The first crushing process includes applying a first pressure to the graphite suspension solution, and the second crushing process includes applying a second pressure to the graphite suspension solution. The second pressure is greater than the first pressure.

According to an embodiment of the invention, a lithium-ion battery electrode includes a metal foil and a conductive mixture disposed on the metal foil. The conductive mixture includes an electrode active component and a conductive additive. A composition of the conductive additive includes the graphene produced by the aforementioned method.

According to an embodiment of the invention, a solution temperature of the graphite suspension solution is lower than 30° C. when performing the first crushing process and the second crushing process.

According to an embodiment of the invention, the graphite material is sheared and exfoliated simultaneously when performing the first crushing process and the second crushing process.

According to an embodiment of the invention, the first pressure is greater than 800 bars, and the second pressure is greater than 1300 bars.

According to an embodiment of the invention, the first crushing process and the second crushing process respectively include pumping the graphite suspension solution through a nozzle of an ultra-high pressure (UHP) crusher several times.

According to an embodiment of the invention, a solid content in the graphite suspension solution is greater than 0.01 wt %.

According to an embodiment of the invention, after performing the second crushing process, the method further includes performing a third crushing process. The third crushing process includes applying a third pressure to the graphite suspension solution, and the third pressure is greater than the second pressure.

According to an embodiment of the invention, the third crushing process includes pumping the graphite suspension solution through a nozzle of an ultra-high pressure crusher several times.

According to an embodiment of the invention, the solution is selected from a group consisting of water, methanol, ethanol, 1-propanol, isopropanol, butanol, isobutanol, ethylene glycol, diethylene glycol, glycerol, propylene glycol, N-methyl-pyrrolidone (NMP), γ-butyrolactone (GBL), 1,3-dimethyl-2-imidazolidinone (DEMU), dimethyl formamide, N-methylpyrrolidinone and a combination thereof. Preferably, the solution is water, ethanol or a combination thereof.

According to an embodiment of the invention, the graphite material is selected from a group consisting of natural graphite, artificial graphite, spheroidal graphite ions, carbon fibers, carbon nanofibers, carbon nanotubes, mesophase carbon micro-bead and a combination thereof.

According to an embodiment of the invention, a lithium-ion battery electrode is provided. A weight percentage of the graphene in the conductive mixture is between 0.01 and 10 wt % calculated based on a solid content.

According to an embodiment of the invention, a composition of the electrode active component is selected from a group consisting of LiFePO₄, LiMn₂O₄, LiCoO₂, Li(NiCo)O₂, Li₂MnO₃)₁₋ₓ(Li(Ni,Mn)O₂)ₓ (x=0.1˜0.8), Li(NiCoAl)O₂ and Li(NiCoMn)O₂.

According to an embodiment of the invention, the lithium-ion battery electrode is disposed in a lithium-ion battery, and the lithium-ion battery includes another metal foil and an electrolyte. An accommodation space is disposed between the metal foils such that the electrolyte is disposed in the accommodation space.

According to an embodiment of the invention, another conductive mixture is disposed on a surface of the another metal foil. A composition of the another conductive mixture includes the graphene produced by the aforementioned method, and a weight percentage of the graphene is 92 wt %.

According to an embodiment of the invention, the composition of the another conductive mixture further includes graphite, soft carbon, hard carbon, or a combination thereof.

These and other features, aspects, and advantages of the present disclosure, as well as the technical means and embodiments employed by the present disclosure, will become better understood with reference to the following description in connection with the accompanying drawings and appended claims.

### BRIEF DESCRIPTION OF THE DRAWINGS

The present disclosure can be more quite understood by reading the following detailed description of the embodiment, with reference made to the accompanying drawings as follows:

FIG. 1 is a scanning electron microscope (SEM) image of graphene and graphite.

FIG. 2 and FIG. 3 show the results of Raman spectrum analysis of the embodiments and comparative embodiments of the invention.

FIG. 4 are the test results of cyclic voltammetry test for graphene and graphite.

FIG. 5 to FIG. 7 are the test results of capacitance of the lithium battery evaluated at different charge and discharge rates (C-rate).

### DESCRIPTION OF THE EMBODIMENTS

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in the respective testing measurements. Also, as used herein, the term “about” generally means within 10%, 5%, 1%, or 0.5% of a given value or range. Alternatively, the term “about” means within an acceptable standard error of the mean when considered by one of ordinary skill in the art. Other than in the operating/working examples, or unless otherwise expressly specified, all of the numerical ranges, amounts, values and percentages such as those for quantities of materials, durations of times, temperatures, operating conditions, ratios of amounts, and the likes thereof disclosed herein should be understood as modified in all instances by the term “about.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as from one endpoint to another endpoint or between two endpoints. All ranges disclosed herein are inclusive of the endpoints, unless specified otherwise.

Unless otherwise defined herein, scientific and technical terminologies employed in the present disclosure shall have the meanings that are commonly understood and used by one of ordinary skill in the art. In addition, unless otherwise required by context, it will be understood that singular terms shall include plural forms of the same and plural terms shall include the singular.

In the present disclosure, the term “graphene” refers to a flat sheet with a thickness of a single atom, which is composed of carbon atoms by sp² bonding, and the carbon atoms of these bondings are arranged in a honeycomb pattern. In the present disclosure, the term “graphene” also refers to a sheet having a layered structure with more than one layer but less than 10 layers. The number of layers may be 1 to 10 layers; preferably, 1 to 8 layers; more preferably, 1 to 5 layers (e.g., 2 to 10 layers or 2 to 5 layers). Generally speaking, when a surface area of the graphene (whether single layer structure or multilayer structure) exceeds 0.005 μm², preferably 0.006 to 0.038 μm², the graphene exists in the form of nanosheets. Alternatively, when the surface area of the graphene is less than 0.005 μm², the graphene exists in the form of nanodots. Unless otherwise indicated herein, the term “graphene” includes pure graphene and the graphene with a small amount of graphene oxide.

The term “graphite” is a terminology well known to one of ordinary skill in the art of the invention, which has a layered flat structure, and each layer includes sheets composed of the carbon atoms by sp² bonding. In the present disclosure, the graphite at least has 11 sheets composed of hexagonal carbons connected to each other by Van der Waals force. In all embodiments of the present disclosure, the graphite may be the graphite in any form and from any source. According to an embodiment of the present disclosure, the graphite used herein is natural graphite, that is, an untreated material. According to another embodiment of the present disclosure, the graphite used herein is artificial graphite.

In the present disclosure, the term “shear” refers to breaking, cracking or deforming a substance, so as to release two or more components, constituents, or composition contained in the substance, or to partially or completely decompose a single component to two or more components/constituents.

The term “exfoliate” refers to a process that a layered or stacked structure is to be layered or not stacked in the present disclosure.

According to an embodiment of the invention, a method of producing graphene is provided as described below.

First, a graphite material is dispersed in a solution to form a graphite suspension solution. An average particle size of the graphite material is between 160 and 190 microns, and the graphite material may be selected from a group consisting of natural graphite, artificial graphite, spheroidal graphite ions, carbon fibers, carbon nanofibers, carbon nanotubes, mesophase carbon micro-beads and a combination thereof. The solution may be selected from a group consisting of water, methanol, ethanol, 1-propanol, isopropanol, butanol, isobutanol, ethylene glycol, diethylene glycol, glycerol, propylene glycol, N-methyl-pyrrolidone, γ-butyrolactone, 1,3-dimethyl-2-imidazolidinone, dimethyl formamide, N-methylpyrrolidinone and a combination thereof.

According to some embodiments of the present disclosure, a solid content of the graphite material in the solution is about between 0.01% and 100% (weight percentage). In other words, 0.01 to 100 grams of the graphite material may be dispersed in 100 grams of the solution. According to a preferred embodiment, the solid content is about between 1% and 10%.

After the graphite suspension solution is obtained, at least a first crushing process and a second crushing process may be performed on the graphite suspension solution sequentially to crush the graphite material, so as to form the graphene. The first crushing process includes applying a first pressure to the graphite suspension solution, and the second crushing process includes applying a second pressure to the graphite suspension solution. In addition, after performing the second crushing process, other crushing processes may be performed subsequently, such as a third crushing process and a fourth crushing process, but is not limited thereto.

Particularly, each of the crushing processes is to inject the graphite suspension solution into an ultra-high pressure (UHP) crusher, and the graphite suspension solution is pumped through a nozzle thereof under a specific condition (e.g., flow rate, pressure and frequency). The graphite material may be sheared and exfoliated gradually by cavitation generated by each of the crushing processes.

According to an embodiment of the invention, the pressures of the crushing processes are different from each other, and the pressure of the latter crushing process is greater than that of the former crushing process. For instance, for the embodiments that the first crushing process, the second crushing process and the third crushing process are performed sequentially, a pumping pressure of the first crushing process may be between 600 bars and 1000 bars, a pumping pressure of the second crushing process may be between 1100 bars and 1500 bars, and a pumping pressure of the third crushing process may be between 1800 bars and 2200 bars, but is not limited thereto. Preferably, the pumping pressures of the first crushing process, the second crushing process and the third crushing process are 800 bars, 1300 bars and 2000 bars respectively.

Each of the crushing processes is performed in an environment less than 30° C. In other words, the operating temperature of the crushing process may be 4, 5, 6, 7, 8, 9, 10, 11, 12, 13, 14, 15, 16, 17, 18, 19, 20, 21, 22, 23, 24, 25, 26, 27, 28, 29 or 30° C. Preferably, the temperature is between 10° C. and 20° C. In an operational embodiment, the temperature is 15° C.

According to an embodiment of the invention, the graphite suspension solution is pumped through the nozzle of the ultra-high pressure crusher several times. In other words, each of the crushing processes is to re-inject the graphite suspension solution obtained after the previous crushing process into the ultra-high pressure crusher. According to an embodiment of the invention, each of the crushing processes may pump the graphite suspension solution through the nozzle at least 3 times at a specific pressure respectively. Thus, an average thickness of the graphene obtained correspondingly is about between 3 and 5 nanometers, and a particle size (d50) thereof is about between 10 and 15 microns.

After performing the crushing processes, a separation process and a drying process may be further performed, such as suction filtration and oven drying, so as to separate solid graphene from the graphite suspension solution.

Compared to the general methods, the advantage of the method of the invention is that chemical reagents (including a reducing agent, an oxidant, a surfactant, an acid and a base, etc.) and ultrasonic treatments commonly used for producing the graphene are not used. Since the method of the invention does not include the chemical reagents, and the whole process is produced at a low temperature, the graphene produced by the method of the invention may have low-defect density.

In order to enable those skilled in the art to implement the present invention, the specific embodiments of the present invention will be further described in detail below to specifically illustrate a method of producing the graphene, a lithium-ion battery electrode including the graphene and a lithium-ion battery including the graphene. It should be noted that the following examples are merely illustrative and restrictive interpretation should not be made to the invention. In other words, the material used, the material usage amount and ratio, processing details and processing procedures, etc., can be suitably modified without departing from the scope of the invention.

Preparation of Graphene

### Embodiment 1

1 g of artificial graphite (about 160 to 190 microns or smaller volume) was dispersed in 100 g of water (solid content is 1 wt %) to form a suspension solution containing the graphite. Then, a first crushing process was performed. The suspension solution containing the graphite was injected into a low temperature ultra-high pressure disrupter (JNBIO-JN10C) and pumped through a nozzle of the ultra-high pressure disrupter at a pressure of 800 bars in an environment of 30° C. for 3 times. In other words, the graphite suspension solution was repeatedly pumped through the ultra-high pressure disrupter at the pressure of 800 bars for 3 times, such that the graphite material was sheared and exfoliated. Then, a second crushing process was performed on the graphite suspension solution treated by the first crushing process. The graphite suspension solution was pumped through the nozzle of the low temperature ultra-high pressure disrupter at a pressure of 1300 bars in an environment of 30° C. for 3 times. Thereafter, a third crushing process was performed on the graphite suspension solution treated by the second crushing process. The graphite suspension solution was pumped through the nozzle of the low temperature ultra-high pressure disrupter at a pressure of 2000 bars in an environment of 30° C. for 3 times. The materials and parameters in Embodiment 1 are described in Table 1.

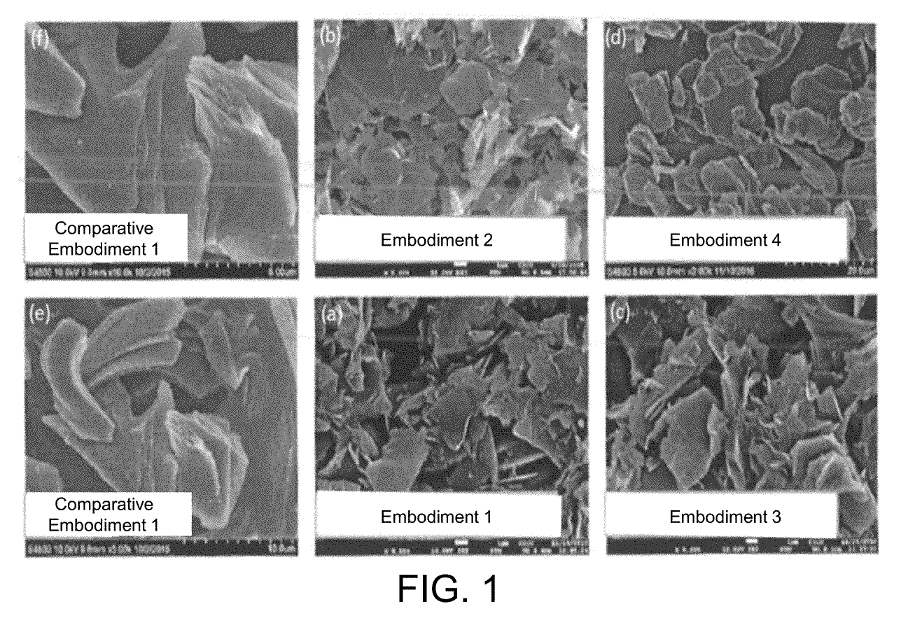

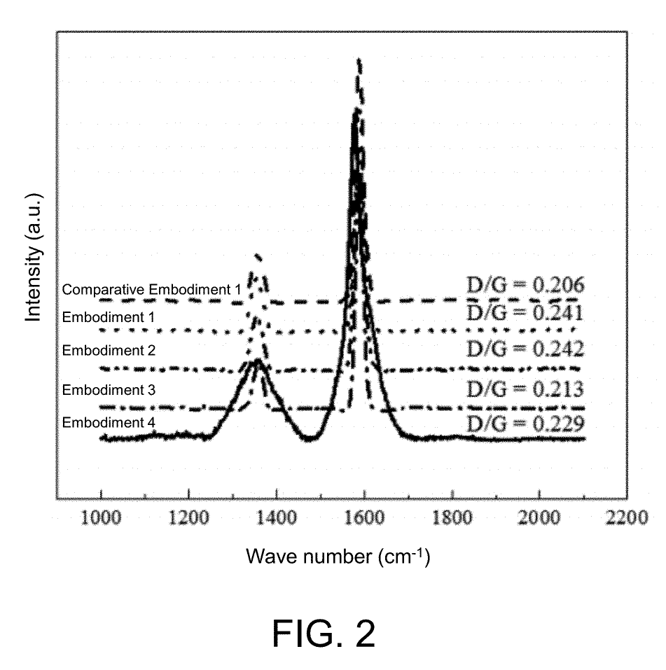

Then, the suction filtration was performed on the graphite suspension solution to initially separate a graphene solid. After that, the graphene solid was placed in an oven to be dehydrated and dried at a temperature of about 40° C. and then stored at room temperature, and was analyzed by a scanning electron microscope (FE-SEM Model S-4800, Hitachi Co., Japan) and a Raman spectrum analyzer (PTT-1532S, PTT co., Taiwan) subsequently. FIG. 1(a) shows a scanning electron microscope (SEM) image of the graphene obtained by Embodiment 1. FIG. 2 shows a Raman spectrum of the graphene of Embodiment 1.

According to FIG. 2, the analysis was performed using a 532 nm laser source. The curve of Embodiment 1 has a D-band located at 1350 cm⁻¹ and a G-band located at 1587 cm⁻¹, and intensity ratios between the D-band and the G-band (D/G) are described in Table 1. Generally speaking, the intensity ratio between the D-band and the G-band (D/G) may be used to determine the defect density of the graphene. The lower the intensity ratio between the D-band and the G-band (D/G), the lower the defect density of the graphene.

According to the present embodiment, by applying the lower pumping pressure (e.g., the first crushing process) first, and then applying the higher pumping pressure (e.g., the second or the third crushing processes), not only the graphite can be crushed to form the graphene solution, but also the dispersivity of the graphite/graphene in the graphite solution can be improved simultaneously. Thus, the degree of crushing of the graphite is more uniform, so as to obtain the graphene having better crushing quality. In other words, by performing each of the crushing processes sequentially, the effects of crushing the graphite and improving the dispersivity of the graphite/graphene can be achieved simultaneously.

### Embodiments 2 to 4

The manufacturing processes of Embodiments 2 to 4 are substantially similar to the manufacturing process of Embodiment 1, and the specific materials and parameters thereof are described in Table 1. In addition, FIG. 1(b) to FIG. 1(d) show scanning electron microscope images of the graphene obtained by Embodiments 2 to 4. FIG. 2 shows Raman spectrums of the graphene of Embodiments 2 to 4, and an intensity ratios between the D-band and the G-band (D/G) of each of the embodiments are described in Table 1.

### Comparative Embodiment 1

Comparative Embodiment 1 is natural graphite, which is not treated by any crushing process, and the specific materials and parameters thereof are described in Table 1. In addition, FIG. 1(e) and FIG. 1(f) show scanning electron microscope images of the natural graphite obtained by Comparative Embodiment 1. FIG. 2 shows a Raman spectrum of the natural graphite of Comparative Embodiment 1, and an intensity ratio between the D-band and the G-band (D/G) thereof is described in Table 1.

### Comparative Embodiment 2

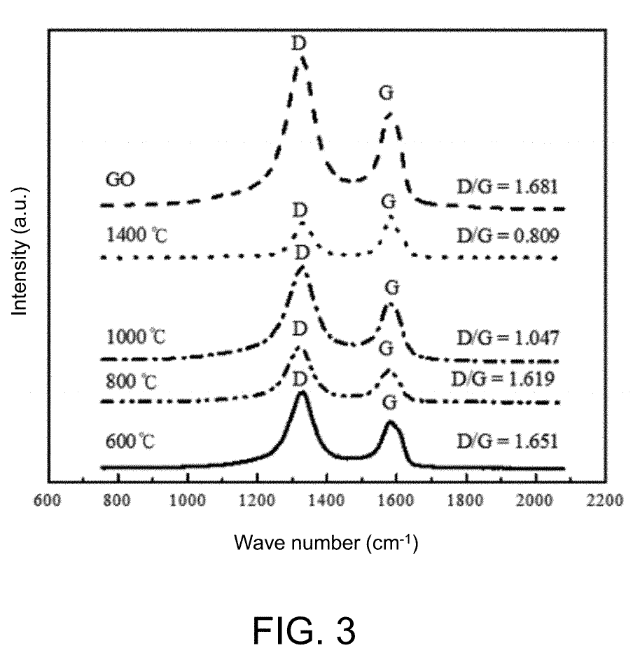

Comparative Embodiment 2 is a graphene oxide, of which the process is that the natural graphite is treated with a strong acid, so that strong acid molecules (e.g., H₂SO₄) are inserted between the layered structure of the natural graphite. Then, a strong oxidant (e.g., KMnO₄) is used to oxidize and exfoliate the natural graphite, so as to obtain the graphene oxide. FIG. 3 shows a Raman spectrum of the graphene oxide of Comparative Embodiment 2 (the curve indicated by GO), and an intensity ratio between the D-band and the G-band (D/G) thereof is described in Table 1.

### Comparative Embodiments 3 to 6

Comparative Embodiments 3 to 6 are thermally reduced graphene. The graphene can be obtained by applying different temperatures (e.g., 600, 800, 1000, 1400) to the graphene oxide of Comparative Embodiment 2. FIG. 3 shows Raman spectrums of the graphene of Comparative Embodiments 3 to 6, and intensity ratios between the D-band and the G-band (D/G) thereof are described in Table 1.

TABLE 1

| | | | | First crushing process | |
|---|---|---|---|---|---|
| | | | Solid | Pumping | |
| | | | content | pressure | Pumping |
| | Source | Solvent | (wt %) | (bar) | times |
| Embodiment 1 | Artificial | Water | 1 | 800 | 3 |
| | graphite | | | | |
| Embodiment 2 | Artificial | Water | 10 | 800 | 3 |
| | graphite | | | | |
| Embodiment 3 | Artificial | N-methylpyrrolidinone | 1 | 800 | 3 |
| | graphite | | | | |
| Embodiment 4 | Artificial | N-methylpyrrolidinone | 10 | 800 | 3 |
| | graphite | | | | |
| Comparative | Artificial | — | — | — | — |
| Embodiment 1 | graphite | | | | |
| Comparative | — | — | — | — | — |
| Embodiment 2 | | | | | |
| Comparative | — | — | — | — | — |
| Embodiment 3 | | | | | |
| Comparative | — | — | — | — | — |
| Embodiment 4 | | | | | |
| Comparative | — | — | — | — | — |
| Embodiment 5 | | | | | |
| Comparative | — | — | — | — | — |
| Embodiment 6 | | | | | |

| Second crushing process | | Third crushing process | | | | |
|---|---|---|---|---|---|---|
| Pumping | | Pumping | | | Pumping | |
| pressure | Pumping | pressure | Pumping | Temperature | rate | |
| (bar) | times | (bar) | times | (° C.) | (L/hr) | D/G |
| 1300 | 3 | 2000 | 3 | 30 | 10 | 0.241 |
| 1300 | 3 | 2000 | 3 | 30 | 10 | 0.242 |
| 1300 | 3 | 2000 | 3 | 30 | 10 | 0.213 |
| 1300 | 3 | 2000 | 3 | 30 | 10 | 0.229 |
| — | — | — | — | — | — | 0.206 |
| — | — | — | — | — | — | 1.681 |
| — | — | — | — | 600 | — | 1.651 |
| — | — | — | — | 800 | — | 1.619 |
| — | — | — | — | 1000 | — | 1.047 |
| — | — | — | — | 1400 | — | 0.809 |

According to the SEM results shown in FIG. 1, compared with the Comparative Embodiment 1 without treatment, the graphite of Embodiments 1 to 4 (respectively corresponding to FIG. 1(a) to FIG. 1(d)) are sheared and exfoliated obviously. In addition, according to the Raman spectrums of FIG. 2 and FIG. 3, since Comparative Embodiment 1 is the natural graphite, the defect density thereof is lowest. In addition, the graphene obtained by the crushing process (Embodiments 1 to 4) may have the defect density similar to that of the natural graphite (Comparative Embodiment 1), that is, the defect density thereof is less than the defect density of the graphene of Comparative Embodiments 2 to 6. Thus, by performing each of the crushing processes, not only the dispersivity of the graphite/graphene in the graphite solution is improved, such that the particle size and the thickness of the graphene will decrease with the increase of pumping pressure and/or times, but also the graphene produced correspondingly may have low-defect density.

Preparation of Graphene Electrode

### Preparation Example 1

First, 4 wt % of polyvinylidene fluoride (PVDF, as an adhesive) and 1-methyl-2-pyrrolidone (NMP, as a solvent) with a weight of 10-30 times of polyvinylidene fluoride were put in a reactor, and were stirred at 2000 rpm for 30 minutes by a homogenizer. Then, 1 wt % of acetylene black (sold by Taiwan Maxwave Co., Ltd, product number is Super P, as a facilitator) and 3 wt % of conductive carbon black (product number is KS6, as a facilitator) were added into the reactor and stirred for 30 minutes. Thereafter, 92 wt % of graphene (Embodiment 1) was added into the reactor and stirred for 30 minutes to obtain a composition containing the graphene (conductive mixture).

Thereafter, the composition containing the graphene was coated on a copper foil (metal foil) with a 100 μm scraper to form a coating, and then dried at 120, so as to obtain a graphene electrode (I) having a graphene layer.

### Preparation Examples 2 to 4

The manufacturing processes of Preparation Examples 2 to 4 are substantially similar to the manufacturing process of Preparation Example 1, and the main difference is that the graphene is replaced by the graphene of Embodiments 2 to 4, so as to produce graphene electrodes (II) to (IV) respectively.

### Preparation Example 5

85 parts by weight of lithium iron phosphate material (as an active component of the positive electrode of the lithium-ion battery), 10 parts by weight of polyvinylidene fluoride (PVDF, as an adhesive) and 5 parts by weight of graphene (Embodiment 2, as a conductive additive) were dispersed in a solvent and stirred for 30 minutes to obtain a composition containing the graphene (conductive mixture).

Thereafter, the composition containing the graphene was coated on an aluminum foil with a 100 μm scraper to form a coating, and then dried at 120, so as to obtain a graphene electrode (V) having a graphene layer.

### Preparation Example 6

The manufacturing process of Preparation Example 6 is substantially similar to the manufacturing process of Preparation Example 5, and the main difference is that the parts by weight of lithium iron phosphate material and the graphene are changed to 80 parts by weight and 10 parts by weight respectively to correspondingly produce a graphene electrode (VI).

### Preparation Example 7

The manufacturing process of Preparation Example 7 is substantially similar to the manufacturing process of Preparation Example 5, and the main difference is that in addition to the lithium iron phosphate material (80 parts by weight), polyvinylidene fluoride (10 parts by weight) and the graphene (7 parts by weight), the conductive additive further includes acetylene black (3 parts by weight) to correspondingly produce a graphene electrode (VII).

### Preparation Example 8

The manufacturing process of Preparation Example 8 is substantially similar to the manufacturing process of Preparation Example 5, and the main difference is that in addition to the lithium iron phosphate material (80 parts by weight), polyvinylidene fluoride (10 parts by weight) and the graphene (3 parts by weight), the conductive additive further includes acetylene black (7 parts by weight) to correspondingly produce a graphene electrode (VIII).

### Preparation Example 9

The manufacturing process of Preparation Example 9 is substantially similar to the manufacturing process of Preparation Example 5, and the main difference is that in addition to the lithium iron phosphate material (80 parts by weight), polyvinylidene fluoride (10 parts by weight) and graphene (7 parts by weight), the conductive additive further includes acetylene black (2 parts by weight) and carbon nanotubes (1 part by weight) to correspondingly produce a graphene electrode (IX).

### Comparative Example 1

The manufacturing process of Comparative Example 1 is substantially similar to the manufacturing process of Preparation Example 1, and the main difference is that the graphene is replaced by the natural graphite of Comparative Embodiment 1, so as to produce graphene electrodes (I).

Production of Battery with Graphene Electrode

### Specific Example 1

The graphene electrode (I) of Preparation Example 1 was cut into an appropriate size (diameter is 14 mm) as a negative electrode with a polyethylene/polypropylene (PE/PP) composite membrane (thickness is 30 μm) as an isolation membrane (ethylene carbonate (EC), diethyl carbonate (DEC), ethyl methyl carbonate (EMC), vinylene carbonate (VC) and 1M of LiPF₆ were injected as an electrolyte) and a lithium metal layer as a positive electrode to be assembled to obtain a button-type lithium battery (I).

### Specific Examples 2 to 4

The manufacturing process of Specific Examples 2 to 4 are substantially similar to the manufacturing process of Specific Example 1, and the main difference is that the graphene electrode (I) is replaced by the graphene electrodes (II) to (IV) of Preparation Examples 2 to 4, so as to produce button-type lithium batteries (II) to (IV) respectively.

### Specific Examples 5 to 9

The graphene electrodes (V) to (IX) of Preparation Examples 5 to 9 were cut into an appropriate size (diameter is 14 mm) as positive electrodes with a polyethylene/polypropylene (PE/PP) composite membrane (thickness is 30 μm) as an isolation membrane (ethylene carbonate (EC), diethyl carbonate (DEC), ethyl methyl carbonate (EMC), vinylene carbonate (VC) and 1M of LiPF₆ as an electrolyte were injected) and the graphene electrode (I) of Comparative Example 1 as a negative electrode to be assembled to obtain button-type lithium batteries (V) to (IX).

### Contrast Example 1

The manufacturing process of Contrast Example 1 is substantially similar to the manufacturing process of Specific Example 1, and the main difference is that the graphene electrode (I) is replaced by the graphite electrode (I) of Comparative Example 1, so as to produce a button-type lithium battery (X).

Hereinafter, electrical properties of the aforementioned graphene and the lithium battery will be tested, and the test items includes: a cyclic voltammetry test, a battery capacity test and a charge and discharge cycle test.

Cyclic Voltammetry Test

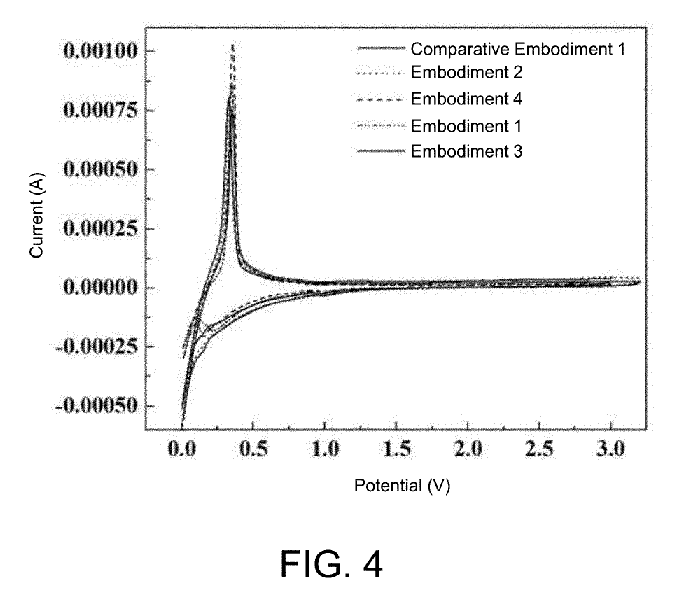

The graphene of Embodiments 1 to 4 and the natural graphite of Comparative Embodiment 1 are subjected to a cyclic voltammetry (CV) test respectively, wherein a cyclic potential range is set to 0.01 to 3 V, and a scan rate is set to 0.1 mVs⁻¹. The test results are illustrated in FIG. 4.

According to the results shown in FIG. 4, the graphene of Embodiments 1 to 4 and the natural graphite of Comparative Embodiment 1 may have almost the same redox peak. In other words, multiple crushing processes do not affect the redox reaction of the graphene.

Relationship between Battery Capacity and Number of Charge and Discharge Cycle Test

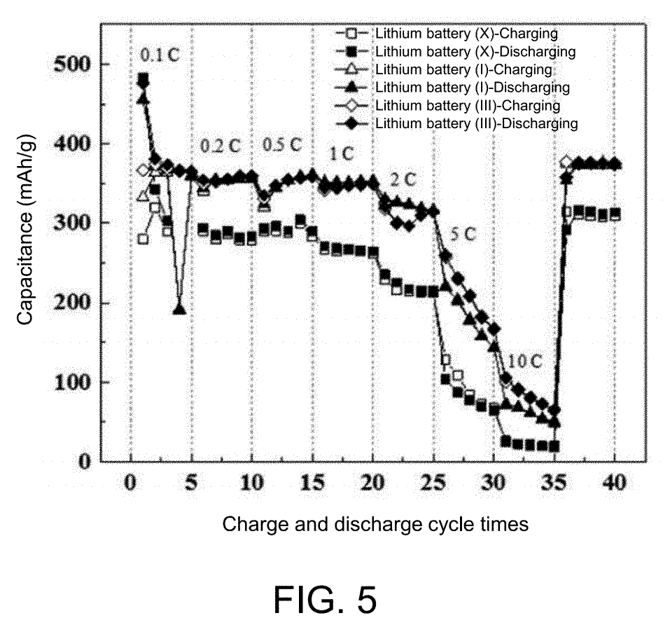

The charge and discharge capacitance of the lithium batteries (I) and (III) of Specific Examples 1 and 3 and the lithium battery (X) of Contrast Example 1 are evaluated at different charge and discharge rates (C-rate). Particularly, the lithium batteries (I) and (III) and the lithium battery (X) cycle at the charge and discharge rate of 0.1C, 0.2C, 0.5C, 1C, 2C, 5C, 10C and 0.1C for 5 times respectively to measure the corresponding capacitance thereof The measured results are referred to FIG. 5.

According to the data shown in FIG. 5, compared with the lithium battery (X) of Contrast Example 1, both the lithium batteries (I) and (III) of Specific Examples 1 and 3 may exhibit better capacitance at different charge and discharge rates. In addition, when returning to the initial charge and discharge rate (0.1C), the lithium batteries (I) and (III) of Specific Examples 1 and 3 may still maintain higher capacitance. Thus, the lithium batteries (I) and (III) of Specific Examples 1 and 3 have better stability in comparison to the lithium battery (X) of Contrast Example 1.

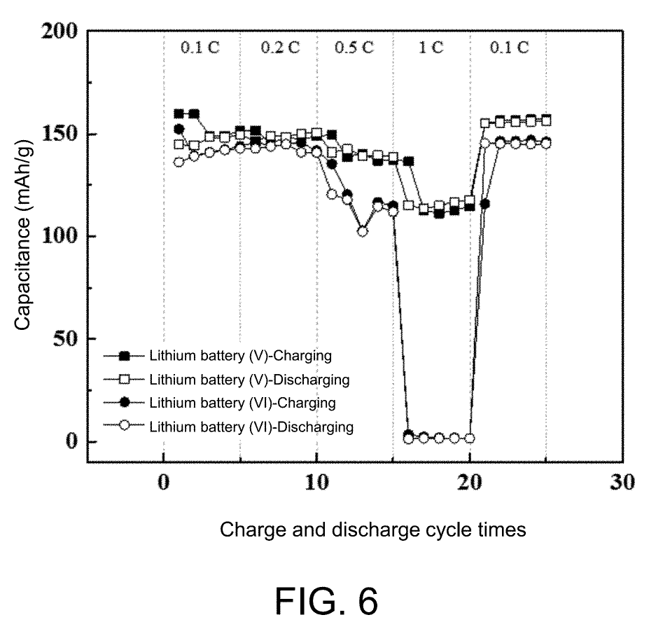

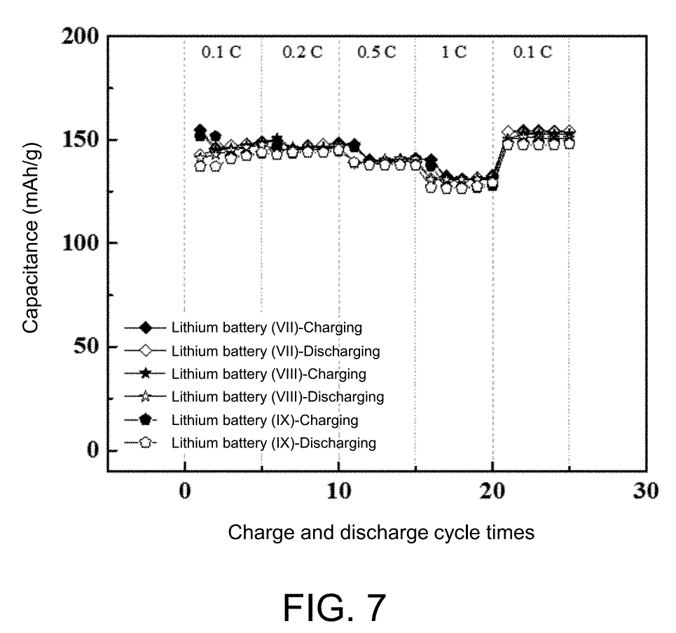

In addition, the charge and discharge capacitance of the lithium batteries (V) to (IX) of Specific Examples 5 to 9 are also evaluated at different charge and discharge rates (C-rate). Particularly, the lithium batteries (V) to (IX) cycle at the charge and discharge rate of 0.1C, 0.2C, 0.5C, 1C and 0.1C for 5 times respectively to measure the corresponding capacitance thereof. The measured results are referred to FIG. 6 and FIG. 7.

According to the data shown in FIG. 6, for the lithium batteries (V) and (VI), the overall performance of the lithium battery (VI) having 10 wt % of graphene (Embodiment 2) is better than that of the lithium battery (V) having 5 wt % of graphene (Embodiment 2). The performance of the two is close at 0.1C and 0.2C, but the performance of the lithium battery (VI) having 10 wt % of graphene (Embodiment 2) is obviously better than that of the lithium battery (V) having 5 wt % of graphene (Embodiment 2).

Further, according to the date shown in FIG. 7, when the composition of the graphene electrodes (VII) to (IX) includes acetylene black and/or the carbon nanotube, the corresponding lithium batteries (VII) and (IX) may still maintain a certain battery capacitance even after multiple charging and discharging and C gradually increases.

Charge and Discharge Cycle Test

The lithium batteries (I) to (IV) of Specific Examples 1 to 4 and the lithium battery (X) of Contrast Example 1 are subjected to a charge and discharge cycle test in a fixed current, and the coulomb efficiency thereof is measured. The results are shown in Table 2.

TABLE 2

| | First cycle | First cycle | Coulomb | Second cycle | Second cycle | Coulomb |
|---|---|---|---|---|---|---|
| | (charging) | (discharging) | efficiency | (charging) | (discharging) | efficiency |
| | mAh/g | mAh/g | (%) | mAh/g | mAh/g | (%) |
| Lithium | 455.75 | 332.76 | 73.0 | 372.42 | 363.84 | 97.6 |
| battery (I) | | | | | | |
| Lithium | 490.09 | 341.78 | 69.7 | 378.98 | 368.11 | 97.1 |
| battery (II) | | | | | | |
| Lithium | 476.68 | 366.40 | 76.8 | 381.13 | 373.59 | 98.02 |
| battery (III) | | | | | | |
| Lithium | 488.29 | 364.75 | 74.6 | 375.83 | 367.68 | 97.8 |
| battery (IV) | | | | | | |
| Lithium | 420.40 | 291.60 | 69.3 | 340.22 | 324.80 | 95.4 |
| battery (X) | | | | | | |

| | Third cycle | Third cycle | Coulomb |
|---|---|---|---|
| | (charging) | (discharging) | efficiency |
| | mAh/g | mAh/g | (%) |
| Lithium | 367.46 | 363.08 | 98.8 |
| battery (I) | | | |
| Lithium | 366.18 | 361.83 | 98.8 |
| battery (II) | | | |
| Lithium | 373.59 | 369.21 | 98.8 |
| battery (III) | | | |
| Lithium | 367.89 | 364.33 | 99.0 |
| battery (IV) | | | |
| Lithium | 333.68 | 318.60 | 95.4 |
| battery (V) | | | |

According to the data shown in Table 2, whether in a first charge and discharge cycle test, a second charge and discharge cycle test or a third charge and discharge cycle test, the coulomb efficiency and the charge and discharge capacitance of the lithium batteries (I) to (IV) having the graphene electrode of the invention are better than that of the lithium battery (X) having the graphite electrode. It is shown that the graphene obtained through multiple crushing processes is more stable and excellent in electrical performance.

In summary, the embodiments of the invention provides the method of producing the graphene from the graphite material (e.g., the natural graphite or the artificial graphite). The method of the invention includes performing multiple crushing processes on the graphite material sequentially in a low temperature environment, and the pressure of the crushing process is increased sequentially. Thus, the graphene with low-defect density and high uniformity can be produced without using any chemical agent and ultrasonic treatment. In addition, the aforementioned graphene has excellent electrochemical properties (both the capacitance and coulomb efficiency increase), and thus is very suitable for the use in an energy storage device.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A graphene structure, wherein a material defect ratio (D/G ratio) of the graphene structure by Raman test is less than 0.24, and the graphene structure is obtained by crushing a graphite material suspension solution.

2. The graphene structure according to claim 1, wherein steps of crushing the graphite material suspension solution comprises:
performing a first crushing process and a second crushing process on the graphite suspension solution sequentially to crush a graphite material in a graphite suspension solution, so as to form graphene, the first crushing process comprising applying a first pressure to the graphite suspension solution, and the second crushing process comprising applying a second pressure to the graphite suspension solution, wherein the second pressure is greater than the first pressure.

3. A method of producing graphene, comprising:
dispersing a graphite material in a solution to form a graphite suspension solution; and
performing a first crushing process and a second crushing process on the graphite suspension solution sequentially to crush the graphite material, so as to form graphene, the first crushing process comprising applying a first pressure to the graphite suspension solution, and the second crushing process comprising applying a second pressure to the graphite suspension solution, wherein the second pressure is greater than the first pressure.

4. The method of producing the graphene according to claim 3, wherein a temperature of the solution is lower than 30° C. when performing the first crushing process and the second crushing process.

5. The method of producing the graphene according to claim 3, wherein the graphite material is sheared and exfoliated simultaneously when performing the first crushing process and the second crushing process.

6. The method of producing the graphene according to claim 3, wherein the first pressure is greater than 800 bars, and the second pressure is greater than 1300 bars.

7. The method of producing the graphene according to claim 3, wherein the first crushing process and the second crushing process respectively comprise pumping the graphite suspension solution through a nozzle of an ultra-high pressure crusher several times.

8. The method of producing the graphene according to claim 1, wherein a solid content in the graphite suspension solution is greater than 0.01 wt %.

9. The method of producing the graphene according to claim 3, wherein after performing the second crushing process, the method further comprises performing a third crushing process, wherein the third crushing process comprises applying a third pressure to the graphite suspension solution, and the third pressure is greater than the second pressure.

10. The method of producing the graphene according to claim 9, wherein the third crushing process comprises pumping the graphite suspension solution through a nozzle of an ultra-high pressure crusher several times.

11. The method of producing the graphene according to claim 3, wherein the solution is selected from a group consisting of water, methanol, ethanol, 1-propanol, isopropanol, butanol, isobutanol, ethylene glycol, diethylene glycol, glycerol, propylene glycol, N-methyl-pyrrolidone, γ-butyrolactone, 1,3-dimethyl-2-imidazolidinone, dimethyl formamide, N-methylpyrrolidinone and a combination thereof.

12. The method of producing the graphene according to claim 3, wherein the graphite material is selected from a group consisting of natural graphite, artificial graphite, spheroidal graphite ions, carbon fibers, carbon nanofibers, carbon nanotubes, mesophase carbon micro-beads and a combination thereof.

13. A lithium-ion battery electrode, comprising:
a metal foil; and
a conductive mixture, disposed on the metal foil, wherein the conductive mixture comprises an electrode active component and a conductive additive, a composition of the conductive additive comprises graphene, and the graphene is produced by the method according to claim 3.

14. The lithium-ion battery electrode according to claim 13, wherein the lithium-ion battery electrode is applied to a positive electrode, and the graphene is between 0.01 and 10 wt % calculated based on an entire solid content of the conductive mixture.

15. The lithium-ion battery electrode according to claim 13, wherein a composition of the electrode active component is selected from a group consisting of LiFePO₄, LiMn₂O₄, LiCoO₂, Li(NiCo)O₂, Li₂MnO₃)₁₋ₓ(Li(Ni,Mn)O₂)ₓ (x=0.1˜0.8), Li(NiCoAl)O₂ and Li(NiCoMn)O₂.

16. The lithium-ion battery electrode according to claim 13, wherein the lithium-ion battery electrode is disposed in a lithium-ion battery, and the lithium-ion battery comprises:
another metal foil, disposed separately from the metal foil having the conductive mixture disposed on a surface thereof, wherein an accommodation space is disposed between the metal foils; and
an electrolyte, disposed in the accommodation space.

17. The lithium-ion battery electrode according to claim 16, wherein the another metal foil is applied to a negative electrode, and another conductive mixture is disposed on a surface of the another metal foil, a composition of the another conductive mixture comprises graphene, the graphene is produced by the method according to claim 3, and a weight percentage of the graphene is 92 wt %.

18. The lithium-ion battery electrode according to claim 17, wherein the composition of the another conductive mixture on the negative electrode further comprises graphite, soft carbon, hard carbon, or a combination thereof.
